(19) United States
(12) Patent Application Publication
(10) Pub. No.: US 2026/0336278 A1
(43) Pub. Date: Oct. 29, 2026

(54) METHOD FOR AUTOMATIC REGISTER CORRECTION IN A PRINTING PRESS

(71) Applicant: Heidelberger Druckmaschinen AG, Heidelberg (DE)

(72) Inventors: Jan Krieger, Heidelberg (DE); Mohammed Benmoussat, Edingen-Neckarhausen (DE)

(21) Appl. No.: 19/654,585

(22) Filed: Apr. 22, 2026

(30) Foreign Application Priority Data
Apr. 29, 2025 (DE) 102025116465.7
Feb. 24, 2026 (DE) 102026107407.3

(51) Int. Cl. B41F 33/00; B41J 2/21; B41J 11/00; B41J 13/26; B41J 29/393; G06K 15/02; G06T 7/00; G06T 7/80

(52) U.S. Cl. CPC B41F 33/0081; B41J 2/2135; B41J 11/0095; B41J 13/26; B41J 29/393; G06K 15/027; G06T 7/0004; G06T 7/80; B41J 2029/3935; G06T 2207/10024; G06T 2207/30144; G06T 2207/30204

(57) ABSTRACT

A method for automatic register correction in a printing press which has at least one image acquisition system for register control. The method is advantageously implemented when circular measurement marks are used and large register deviations occur. Two digital correction methods are carried out in parallel in a computer, and, depending on the extent of the register misalignment, either a coarse correction method or a fine correction method is transmitted to the printing press.

### CROSS-REFERENCE TO RELATED APPLICATION

This application claims the priority, under 35 U.S.C. § 119, of German Patent Application DE 10 2025 116 465.7, filed Apr. 29, 2025; the prior application is herewith incorporated by reference in its entirety.

### FIELD AND BACKGROUND OF THE INVENTION

The present disclosure relates to a method for automatic register correction in a printing press. More specifically, the present disclosure relates to a computer-implemented method for determining and correcting register misalignment, wherein circular measurement marks are used for the precise determination of the deviations.

In the field of printing technology, it is common for printing presses to perform precise register and alignment corrections in order to achieve high print quality. Such corrections are essential to ensuring that the various color separations of a printed image are accurately superimposed and that no visible shifts or blurring occur. Known systems for register correction often rely on manual or semi-automated methods in which an operator monitors the printing press and performs adjustments. However, such methods are time-consuming and prone to human error, which can result in inconsistent print quality. Automated systems based on optical sensors or cameras are also used, but they frequently reach their limits with regard to correction accuracy and response speed.

Known systems typically employ the use of register marks printed on the substrate to detect misalignment. These marks are detected by sensors, and the resulting data are used to calculate correction values. A common problem with such systems, however, is their limited accuracy. In addition, the algorithms used to calculate corrections are often unable to respond sufficiently quickly to changes in the printing process, which may lead to delays and increased waste.

A further problem with existing systems is their dependence on the quality of the printed register marks. Contamination or non-uniform printing conditions may impair the detection and evaluation of the marks, leading to erroneous corrections. Moreover, many systems require extensive calibration of the sensors in order to achieve accurate results, which increases setup effort and reduces flexibility of the printing press. The integration of such systems into existing printing presses may also present challenges, particularly when the machines are designed for high printing speeds.

A particularly problematic situation arises in camera-based systems for register correction when circular measurement marks approach one another very closely or even overlap, i.e., when the register error is very large. This occurs in particular with very small marks, which are often used due to their minimal space requirements on the substrate sheet. In such cases, known methods exhibit weaknesses that can lead to insufficient correction of the register error. Despite considerable advances in automated print correction, a need remains for systems that provide both high accuracy and acceptable response time in camera-based correction systems, particularly in the case of large misalignments of circular measurement marks.

German published patent application DE 10 2019 211 758 A1 and its counterpart U.S. Pat. No. 11,267,264 B2 describe a method for automated register and alignment measurement in a printing press using a computer, in which circular measurement marks are used.

German published patent application DE 10 2018 211 922 A1 and its counterpart U.S. Pat. No. 10,500,842 B2 describe a method for automated image sensor calibration of print heads in an inkjet printing press, in which test print patterns composed of circular disks are printed and digitally evaluated by means of a computer.

### SUMMARY OF THE INVENTION

It is accordingly an object of the invention to provide a method and a corresponding printing machine which overcomes the above-mentioned and other disadvantages of the heretofore-known devices and methods of this general type and which provides for a method for automatic register correction in a printing press that enables more precise and efficient correction, thereby improving print quality, shortening production time, minimizing material consumption, and thus overcoming one or more disadvantages of the prior art.

With the above and other objects in view there is provided, in accordance with the invention, a computer-assisted method for register correction in a printing press, wherein at least one test pattern with a plurality of color separations is printed onto a substrate, with each color separation having at least one circular measurement mark with a diameter defined prior to printing onto the substrate; the at least one test pattern is captured by an image acquisition system as a digital test pattern image; the digital test pattern image is subjected to an evaluation by a computer with respect to register misalignment, wherein a center position of each circular measurement mark is determined from the digital test pattern image and the register misalignment is calculated; and a misalignment that is present is corrected by the computer controlling the printing press on a basis of the evaluation.

The method comprises the following steps:
i) prior to controlling the printing press by the computer, during evaluation of the digital test pattern image, separately carrying out a first digital correction method and a second digital correction method in the computer, wherein the first digital correction method is configured to calculate a register misalignment with higher accuracy than the second digital correction method;
ii) determining by the computer whether the first digital correction method completely corrects the register misalignment; and
   ii.1) when the first digital correction method is determined to completely correct the register misalignment, controlling the printing press by the computer to correct the register misalignment with the first digital correction method; and
   ii.2) when the first digital correction method is determined not to completely correct the register misalignment, controlling the printing press by the computer to correct the register misalignment with the second digital correction method, printing at least one further test pattern with a plurality of color separations by the printing press onto a substrate, capturing the at least one further test pattern by the image acquisition system as a further digital test pattern image, subjecting the further digital test pattern image to the evaluation by the computer with respect to a register misalignment, with the evaluation using the first digital correction method, and subsequently controlling the printing press by the computer to correct the register misalignment with the first digital correction method.

The method is particularly suitable for use in camera-based correction systems employing circular measurement marks.

The method according to the invention is capable of correcting register misalignment both quickly and accurately. By theoretically executing a coarse correction method and a fine correction method in parallel within the computer and transmitting the more suitable method to the printing press depending on the situation, time and waste are reduced. The finer correction method, which may fail in the case of very large register deviations, is, if necessary, preceded by a coarse correction method, such that the fine correction method can ultimately be applied advantageously for precise register correction.

Accordingly, a first aspect of the present invention relates to a method for register correction in a printing press by means of a computer, wherein at least one test pattern with a plurality of color separations is printed by the printing press onto a substrate, and the at least one test pattern is captured by at least one image acquisition system in the form of a digital test pattern image, the digital test pattern image is evaluated by the computer with respect to register misalignment, and the computer corrects an existing register misalignment by controlling the printing press based on this evaluation. Specifically, each color separation comprises at least one circular measurement mark having a diameter defined prior to printing onto the substrate, and the computer determines the center position of each circular measurement mark from the digital test pattern image and thereby calculates the register misalignment. The novel method is characterized in that:
i) prior to controlling the printing press, during evaluation of the digital test pattern image, a first digital correction method and a second digital correction method are carried out separately from one another in the computer, wherein the first digital correction method calculates the register misalignment with higher accuracy than the second digital correction method,
ii) the computer determines whether the first digital correction method substantially completely corrects the register misalignment, and
   ii.1) if the first digital correction method substantially completely corrects the register misalignment, the computer controls the printing press to correct the register misalignment based on the first digital correction method, and
   ii.2) if the first digital correction method does not substantially completely correct the register misalignment, the computer controls the printing press to correct the register misalignment on the basis of the second digital correction method, at least one further test pattern comprising a plurality of color separations is printed by the printing press onto a substrate, the at least one further test pattern is captured by means of the at least one image acquisition system in the form of a further digital test pattern image, the further digital test pattern image is evaluated by the computer with respect to register misalignment, wherein said evaluation comprises the first digital correction method, and the computer then controls the printing press to correct the register misalignment on the basis of the first digital correction method.

In a preferred embodiment, the method according to the invention is carried out continuously during a print job in the printing press. In a particularly preferred embodiment, the method according to the invention is carried out for each substrate sheet of the print job in the printing press. As a result, each substrate sheet is checked for correct register, and, if a deviation is detected, subsequent substrate sheets are corrected. However, it is also possible, for example, to check only every second or third substrate sheet for register misalignment using the method according to the invention.

In a further preferred embodiment, the method according to the invention is performed during a print job in the printing press only upon request by an operator of the printing press. In this preferred embodiment, when register misalignment is detected, the operator is preferably alerted by an acoustic or visual signal indicating that register misalignment has been detected. Various detection methods for register misalignment may be used for this purpose; for example, purely visual inspection of the substrate by the operator is also possible. The operator may then initiate the method according to the invention in order to correct the register misalignment.

In a further preferred embodiment, the register misalignment is continuously detected and calculated during a print job in the printing press in accordance with the method according to the invention. However, control of the printing press to correct the register misalignment is carried out only upon request by the operator of the printing press, preferably following an acoustic or visual signal triggered by the computer. This makes it possible to continuously monitor the register misalignment while performing corrections only when required.

In a further preferred embodiment, in both the first digital correction method and the second digital correction method, the computer determines the center position of each circular measurement mark from the digital test pattern image and calculates the register misalignment on this basis. In a particularly preferred embodiment, the computer determines the center position of each circular measurement mark from the digital test pattern image by determining the centroid of each circular measurement mark. In this context, the term “centroid” refers to the geometric center of the circular measurement marks, which is determined by analyzing the distribution of pixel intensities within the digital image. This method takes advantage of the fact that the circular measurement marks exhibit a uniform color distribution, allowing the centroid to be localized with high precision. The advantage of this method lies in its robustness and efficiency, enabling rapid and reliable determination of the positions of the measurement marks, even when print quality or image acquisition conditions vary. A method for determining the centroids of such measurement marks is described, for example, in the above-mentioned DE 10 2019 211 758 A1 and U.S. Pat. No. 11,267,264 B2. In a particularly preferred embodiment, in the first digital correction method, the computer determines the center position of each circular measurement mark from the digital test pattern image using a subpixel-accurate, model-based parameter fitting method. This may be carried out, for example, using a method as described in the above-mentioned DE 10 2018 211 922 A1and U.S. Pat. No. 10,500,842 B2. Such a method employs a model-based approach in which a mathematical model of the image of a circular disk is fitted to the actually captured image. In this process, the parameters of the model, including in particular the center position of the circular disk, are determined with high precision. This modeling approach has the advantage that it also accounts for noise in the image sensors.

In a further preferred embodiment, in step ii), the computer determines that the first digital correction method substantially completely corrects the register misalignment when the deviation of the center positions of the circular measurement marks from a predefined target value falls below a tolerance threshold. If the tolerance threshold is exceeded, the first, more accurate digital correction method is not used to correct the register misalignment. Instead in this case, the second, less accurate digital correction method is used to perform a coarse correction of the register until the deviation of the center positions again falls below the tolerance threshold. The first, more accurate correction method is then applied to perform fine correction of the register.

In a further preferred embodiment, prior to capturing the digital test pattern image, the at least one image acquisition system is calibrated using calibration points printed on the substrate. In this way, the image acquisition system can be calibrated or recalibrated initially or at regular intervals.

In a further preferred embodiment, the at least one image acquisition system comprises at least one inline camera of the printing press. For example, the image acquisition system may comprise two inline cameras, wherein each inline camera captures a different side of a double-sided printed substrate. In this case, each inline camera may provide a separate digital test pattern image. It is also possible to use an image acquisition system comprising four inline cameras, wherein two inline cameras capture the front side of the substrate and two inline cameras capture the reverse side of the substrate. Each inline camera may thereby cover a different half of the substrate sheet.

In a further preferred embodiment, the circular measurement marks are arranged on the substrate such that they are fully captured by the at least one image acquisition system and represented within a single digital test pattern image. In a particularly preferred embodiment, the at least one image acquisition system captures substantially only the region in which the circular measurement marks are located and transmits only this region to the computer as the digital test pattern image for evaluation.

In a further preferred embodiment, the circular measurement marks for each color separation are selected from filled circular disks having a predefined diameter and unfilled circular disks in the form of annular rings having a predefined diameter. Such measurement marks are described, for example, in DE 10 2018 211 922 A1 and U.S. Pat. No. 10,500,842 B2.

In a further preferred embodiment, the circular measurement marks are arranged in a print control strip on the substrate.

With the above and other objects in view there is also provided, in accordance with the invention, a printing press configured to carry out the method according to the invention. In a preferred embodiment, the printing press is an offset printing press, a flexographic printing press, ore an inkjet printing press.

Other features which are considered as characteristic for the invention are set forth in the appended claims.

Although the invention is illustrated and described herein as embodied in a method for automatic register correction in a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic illustration of a printing press in which the method according to the invention is carried out.

FIG. 2 is a schematic showing a test pattern with ideal positions for circular measurement marks to be printed.

FIG. 3 is a schematic view showing three circular measurement marks printed onto the test pattern.

FIG. 4 is a similar view showing three circular measurement marks printed onto the test pattern.

### DETAILED DESCRIPTION OF THE INVENTION

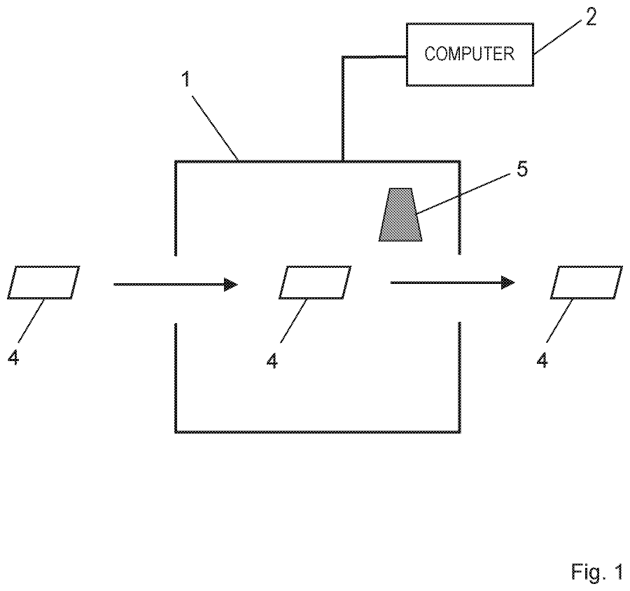

Referring now to the figures of the drawing in detail and first, in particular, to FIG. 1 thereof, there is shown a highly schematic illustration of a printing press in which a preferred embodiment of the method according to the invention is carried out. A sheet of a substrate 4 is fed into the printing press 1, which is an offset printing press, and is printed. An image acquisition system 5, in the form of a camera within the printing press, captures the test pattern 3 on the substrate 4 as a digital test pattern image and transmits it to the computer 2. The computer 2 carries out the first digital correction method and the second digital correction method separately from one another in the memory and determines that the first digital correction method is not suitable due to a larger register misalignment. Accordingly, the computer 2 transmits only the second digital correction method to the printing press 1 for execution. After the second digital correction method has been executed in the printing press 1 to correct the register misalignment, further test patterns 3 are printed, and both the first digital correction method and the second digital correction method are again executed in the computer 2. The computer 2 then determines that the first digital correction method is suitable and therefore transmits only the first digital correction method to the printing press 1 to correct the register misalignment.

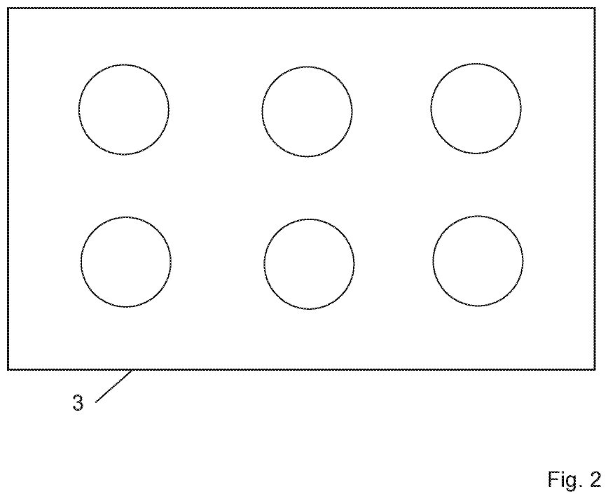

FIG. 2 schematically shows a test pattern 3 with ideal positions, indicated by six circles, for circular measurement marks 6 to be printed. No test marks are yet shown on the test pattern template.

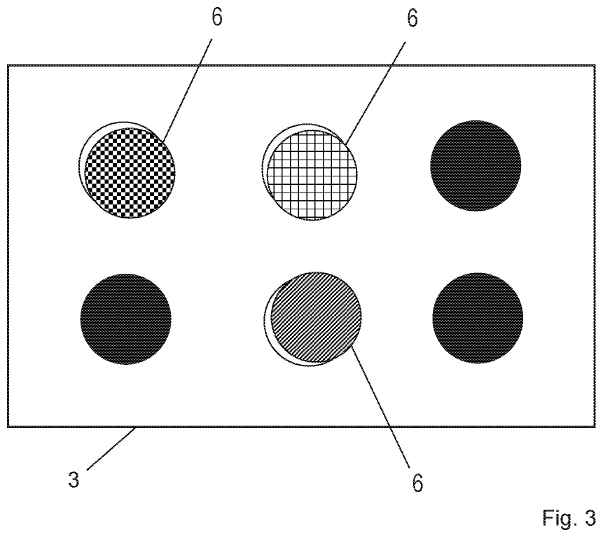

FIG. 3 schematically shows a test pattern 3 with three printed circular measurement marks 6. The deviations of the three circular measurement marks 6 from their ideal positions are comparatively small. The three additional circular measurement marks shown are printed using a reference color separation and serve as reference points for calibrating the image acquisition system.

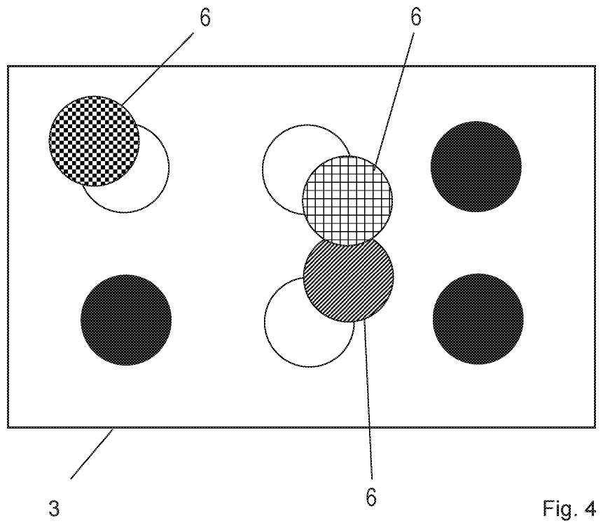

FIG. 4 schematically shows a test pattern 3 with three printed circular measurement marks 6. Here, the deviations of the three circular measurement marks 6 from their ideal positions are comparatively large and, in some cases, even result in overlap of the circular measurement marks 6; see the checkered measurement mark and the hatched measurement mark in the middle column. The three additional circular measurement marks shown are printed using a reference color separation and serve as reference points for calibrating the image acquisition system. When such a test pattern 3 occurs, the two-stage method according to the invention for register correction can be applied with particular advantage.

The following is a summary list of reference numerals and the corresponding structure used in the above description of the invention:
1 Printing press
2 Computer, processor
3 Test pattern
4 Substrate
5 Image acquisition system
6 Circular measurement mark

1. A computer-assisted method for register correction in a printing press, wherein:
at least one test pattern with a plurality of color separations is printed onto a substrate, with each color separation having at least one circular measurement mark with a diameter defined prior to printing onto the substrate;
the at least one test pattern is captured by an image acquisition system as a digital test pattern image;
the digital test pattern image is subjected to an evaluation by a computer with respect to register misalignment, wherein a center position of each circular measurement mark is determined from the digital test pattern image and the register misalignment is calculated; and
an existing misalignment is corrected by the computer controlling the printing press on a basis of the evaluation;
the method comprising:
i) prior to controlling the printing press by the computer, during evaluation of the digital test pattern image, separately carrying out a first digital correction method and a second digital correction method in the computer, wherein the first digital correction method is configured to calculate a register misalignment with higher accuracy than the second digital correction method;
ii) determining by the computer whether the first digital correction method completely corrects the register misalignment; and
ii.1) when the first digital correction method is determined to completely correct the register misalignment, controlling the printing press by the computer to correct the register misalignment with the first digital correction method; and
ii.2) when the first digital correction method is determined not to completely correct the register misalignment, controlling the printing press by the computer to correct the register misalignment with the second digital correction method, printing at least one further test pattern with a plurality of color separations by the printing press onto a substrate, capturing the at least one further test pattern by the image acquisition system as a further digital test pattern image, subjecting the further digital test pattern image to the evaluation by the computer with respect to a register misalignment, with the evaluation using the first digital correction method, and subsequently controlling the printing press by the computer to correct the register misalignment with the first digital correction method.

2. The method according to claim 1, which comprises continuously carrying out the method during a print job in the printing press.

3. The method according to claim 1, which comprises carrying out the method during a print job in the printing press only upon a request by an operator of the printing press.

4. The method according to claim 1, which comprises, during a print job in the printing press, continuously calculating the register misalignment and correcting the register misalignment only upon a request by an operator of the printing press.

5. The method according to claim 1, which comprises, in the first digital correction method and in the second digital correction method, determining the center position of each circular measurement mark from the digital test pattern image and calculating the register misalignment based thereon.

6. The method according to claim 1, which comprises determining by the computer the center position of each circular measurement mark from the digital test pattern image by determining a centroid of each circular measurement mark.

7. The method according to claim 1, which comprises determining by the computer the center position of each circular measurement mark in the first digital correction method from the digital test pattern image by a subpixel-accurate, model-based parameter fitting method.

8. The method according to claim 1, wherein, in step ii), the computer determines that the first digital correction method completely corrects the register misalignment when a deviation of a center position of the circular measurement marks from a predefined target value falls below a tolerance threshold.

9. The method according to claim 1, which comprises, prior to capturing the digital test pattern image, calibrating the image acquisition system using calibration points printed on the substrate.

10. The method according to claim 1, wherein the image acquisition system comprises at least one inline camera of the printing press.

11. The method according to claim 1, wherein the circular measurement marks are arranged on the substrate to enable the circular measurement marks to be fully captured by the image acquisition system and represented within a single digital test pattern image.

12. The method according to claim 1, which comprises providing the circular measurement marks for each color separation as filled circular disks having a predefined diameter or unfilled circular disks in a form of annular rings having a predefined diameter.

13. The method according to claim 1, which comprises arranging the circular measurement marks in a print control strip on the substrate.

14. A printing press configured to carry out the method according to claim 1.
